(19) United States
(12) Patent Application Publication
(10) Pub. No.: US 2009/0128844 A1
(43) Pub. Date: May 21, 2009

(54) SYSTEM OF A PLURALITY OF IMAGE FORMING APPARATUSES, DISPLAY METHOD THEREIN AND SERVER DIRECTED THERETO

(75) Inventors: Atsushi Kondo, Itami-shi (JP); Masato Fujii, Nagaokakyo-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/101,429

(22) Filed: Apr. 11, 2008

(30) Foreign Application Priority Data
Nov. 15, 2007 (JP) 2007-297074

(51) Int. Cl. G06F 15/00

(52) U.S. Cl. 358/1.15

(57) ABSTRACT

An image forming apparatus MFP requests, when a user operates the image forming apparatus, input of a user ID for identifying the user. The image forming apparatus MFP obtains customizing information corresponding to the input user ID from a server SRV, and in accordance with the obtained customizing information, changes display mode of an operation panel. The customizing information is formed allowing setting by each user of the image forming apparatus MFP, and each user can arbitrarily set the display image to be convenient for use by the user.

This application is based on Japanese Patent Application No. 2007-297074 filed with the Japan Patent Office on Nov. 15, 2007, the entire content of which is hereby incorporated by reference.

### BACKGROUND OF THE INVENTION

1. Field of the Invention

The present invention relates to a system including a plurality of image forming apparatuses, a display method in the system and a server directed to the system and, more specifically, it relates to a technique for providing a customizable user interface.

2. Description of the Related Art

With rapid development of information techniques of late, image forming apparatuses such as a Multi Function Peripheral (hereinafter also simply referred to as “MFP”) come to have higher functions. Specifically, functions of color printing, stapling, punching and folding of output sheets of paper have been added and functions of copying, scanning, facsimile have been integrated (multi-functions). As a result, display images appearing on an operation panel (user interface) come to include a large member of buttons and the like to attain various functions that are supported.

On the other hand, among the large number of functions supported by the image forming apparatus, only a few specific functions may be sufficient for some users, For such a user, display of large number of buttons on the screen is unnecessary, and simple display of buttons necessary for attaining frequently used functions would be more convenient.

In view of the foregoing, an image forming apparatus allowing user-by-user customization of display image has been proposed. By way of example, Japanese Laid-Open Patent Publication No. 2005-198140 discloses a multi function peripheral that can retrieve customized menu from an individual information server and display the same for each registered user.

In offices having a plurality of image forming apparatuses installed, sometimes only some of the image forming apparatuses are renewed, and old and new types of apparatuses exist together. It is often the case that in an image forming apparatus supporting a new function or functions, images on the display screen are displayed in a different manner. Therefore, in an environment where old and new types of apparatuses exist together as mentioned above, such difference in operation procedures may be confusing to users.

In the image forming apparatus disclosed in Japanese Laid-Open Patent Publication No. 2005-198140 mentioned above, it is not assumed in providing the customized menu that functions (capabilities) supported by image forming apparatuses are not the same. Therefore, when there are a number of users in an environment having a plurality of image forming apparatuses installed, it becomes necessary to set customized menus same in number as the number of users in each image forming apparatus, requiring considerable labor for the task of setting.

### SUMMARY OF THE INVENTION

The present invention was made to solve such a problem and its object is to provide a system, a display method and a server that can appropriately realize a user interface preferred by each user in accordance with capability of the image forming apparatus, by a simple setting operation.

According to an aspect, the present invention provides a system, including: a plurality of image forming apparatuses, and a server capable of data communication with the plurality of image forming apparatuses. Each of the image forming apparatuses includes a display portion displaying information related to an operation of the image forming apparatus, and a receiving portion receiving identification information identifying a user using the image forming apparatus and transmitting the identification information to the server. The server includes a storage portion for storing first setting information set user by user in advance, a generating portion responsive to the identification information from the image forming apparatus, for generating second setting information by deleting any item other than those supported by the image forming apparatus from the first setting information corresponding to the identification information, and a returning portion returning the second setting information to the image forming apparatus. Each of the plurality of image forming apparatuses further includes a display control portion providing, on the display portion, information related to the operation in a display mode based on the second setting information returned from the server.

Preferably, each of the plurality of image forming apparatuses further includes a capability information transmitting portion transmitting capability information indicating a function supported by itself to the server. The generating portion generates the second setting information based on the capability information from the image forming apparatus.

Preferably, the server further includes a table for storing beforehand capability information indicating a function supported by each of the image forming apparatuses, in correspondence with the plurality of image forming apparatuses. The generating portion looks up the table to obtain capability information corresponding to the image forming apparatus as a transmission source of the identification information, and generates the second setting information based on the obtained capability information.

Preferably, the storage portion is capable of storing, user by user, at least one piece of the first setting information for each of the image forming apparatuses. The returning portion returns that piece of first setting information which corresponds to the image forming apparatus as the transmission source of the identification information, to the image forming apparatus.

Preferably, the display control portion displays the information related to the operation in a predetermined, prescribed display mode, if the second setting information is not effectively returned from the server.

Preferably, the system further includes a user terminal capable of data communication with the server. The server further includes a setting portion invoking a display of an image for setting the first setting information on the user terminal and storing the first setting information in the storage portion in accordance with a set value input through the user terminal.

Preferably, the first setting information includes a setting value for at least one of display items, a layout, a font type and a color.

According to another aspect, the present invention provides a display method in a system including a plurality of image forming apparatuses and a server capable of data communication with the plurality of image forming apparatuses. Each of the image forming apparatuses includes a display portion displaying information related to an operation of the image forming apparatus, and the server includes a storage portion for storing first setting information set user by user in advance. The display method includes the steps of: the image forming apparatus receiving identification information for identifying a user who uses it, and transmitting the identification information to the server; in response to the identification information from the image forming apparatus, the server generating second setting information by deleting any item other than those supported by the image forming apparatus from the first setting information corresponding to the identification information; the server returning the second setting information to the image forming apparatus; and the image forming apparatus displaying the information related to an operation in a display mode based on the second setting information returned from the server.

Preferably, the display method further includes the step of the image forming apparatus transmitting capability information indicating a function supported by itself to the server. The generating step includes the step of generating the second setting information based on the capability information from the image forming apparatus.

Preferably, the server further includes a table for storing beforehand capability information indicating a function supported by each of the image forming apparatuses, in correspondence with the plurality of image forming apparatuses. The generating step includes the step of looking up the table to obtain capability information corresponding to the image forming apparatus as a transmission source of the identification information, and generating the second setting information based on the obtained capability information.

Preferably, the storage portion is capable of storing, user by user, at least one piece of the first setting information for each of the image forming apparatuses. The returning step includes the step of returning that piece of first setting information which corresponds to the image forming apparatus as the transmission source of the identification information, to the image forming apparatus.

Preferably, the displaying step includes the step of displaying the information related to the operation in a predetermined, prescribed display mode, if the second setting information is not effectively returned from the server.

Preferably, the system further includes a user terminal capable of data communication with the server. The display method further includes the step of the server invoking a display of an image for setting the first setting information on the user terminal, and storing the first setting information in the storage portion in accordance with a set value input through the user terminal.

Preferably, the first setting information includes a setting value for at least one of display items, a layout, a font type and a color.

According to a still further aspect, the present invention provides a server capable of data communication with a plurality of image forming apparatuses and with a user terminal Each of the plurality of image forming apparatuses includes a display portion displaying information related to an operation of the image forming apparatus. The server includes a storage portion for storing first setting information set user by user in advance, for defining display mode of the information related to an operation in the image forming apparatus; a setting portion invoking a display of an image for setting the setting information in the user terminal, and storing the setting information in the storage portion in accordance with a set value input through the user terminal; a generating portion responsive to reception of identification information for identifying a user from the image forming apparatus, generating second setting information by deleting any item other than those supported by the image forming apparatus from the first setting information corresponding to the identification information; and a returning portion returning the second setting information to the image forming apparatus.

According to the present invention, user interface preferred by each user can appropriately be realized in accordance with the capability of the image forming apparatus, by a simple setting operation.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic configuration of the system in accordance with an embodiment of the present invention.

FIG. 2 is a schematic diagram showing a hardware configuration of an image forming apparatus in accordance with the embodiment of the present invention,

FIG. 3 shows a typical appearance of an operation panel of the image forming apparatus in accordance with the embodiment of the present invention,

FIG. 4 is a schematic diagram showing a hardware configuration of a server in accordance with the embodiment of the present invention.

FIG. 5 is a sequence diagram representing process procedure related to setting of customizing information in the system in accordance with the embodiment of the present invention.

FIG. 6 is a sequence diagram representing process procedure related to display in accordance with the customizing information, in the image forming apparatus in accordance with the embodiment of the present invention.

FIG. 7 is a block diagram representing a functional configuration of a personal computer in accordance with the embodiment of the present invention,

FIG. 8 is a block diagram representing functional configuration of the server in accordance with the embodiment of the present invention.

FIG. 9 is a block diagram representing functional configuration of the image forming apparatus in accordance with the embodiment of the present invention.

FIG. 10 shows an exemplary display given on a touch panel of the image forming apparatus in accordance with the embodiment of the present invention.

FIG. 11 shows an exemplary setting window for customization, displayed on the personal computer in accordance with the embodiment of the present invention,

FIG. 12 shows an example of an advanced setting menu displayed on the setting window shown in FIG. 11.

FIG. 13 shows an example of an advanced item setting window displayed following the setting window of FIG. 11.

FIG. 14 shows an example of a short cut setting window displayed following the setting window of FIG. 11.

FIGS. 15 and 16 show examples of source code of the customizing information generated using the setting window shown in FIG. 11.

FIGS. 17A and 17B show examples of display changed by the server dependent on the capability of the image forming apparatus, in accordance with the embodiment of the present invention.

FIG. 18 shows another exemplary display given on the touch panel of the image forming apparatus in accordance with the embodiment of the present invention,

FIG. 19 shows a still another exemplary display given on the touch panel of the image forming apparatus in accordance with the embodiment of the present invention.

FIG. 20 shows a still further exemplary display given on the touch panel of the image forming apparatus in accordance with the embodiment of the present invention.

FIG. 21 is a block diagram representing functional configuration of the server in accordance with Modification 1 of the embodiment of the present invention,

FIG. 22 is a sequence diagram representing a process procedure related to display in accordance with the customizing information, in the image forming apparatus in accordance with Modification 1 of the embodiment of the present invention.

### DESCRIPTION OF THE PREFERRED EMBODIMENTS

Embodiments of the present invention will be described in detail with reference to the figures. In the figures, the same or corresponding portions are denoted by the same reference characters and description thereof will not be repeated.

<Overall System Configuration>

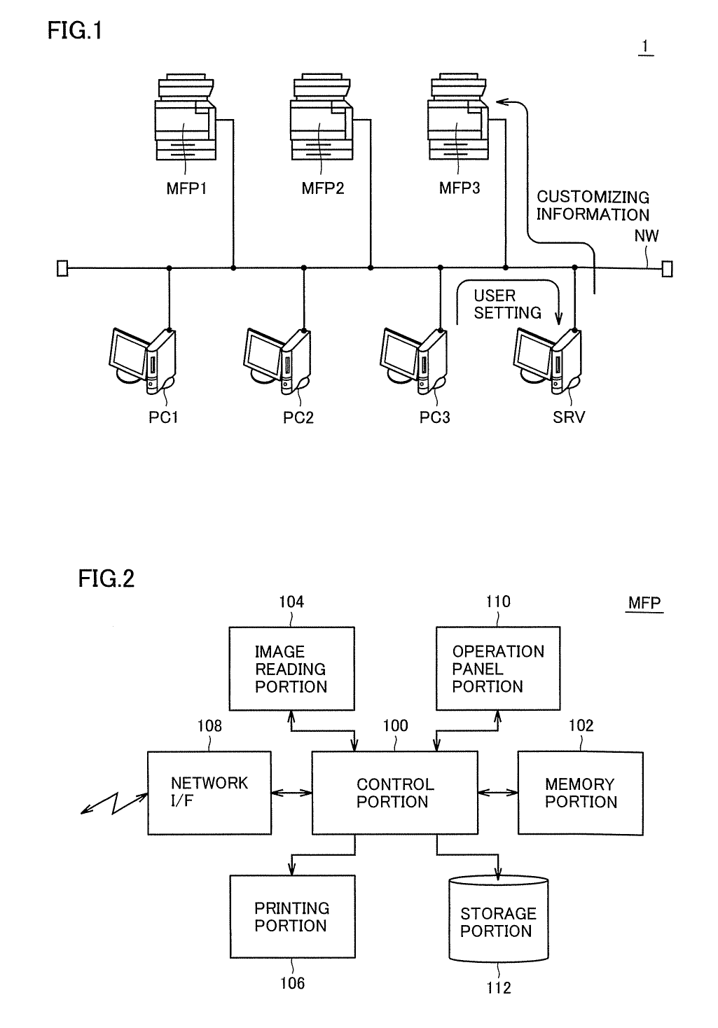

Referring to FIG. 1, a system 1 in accordance with the present embodiment includes a plurality of image forming apparatuses MFP1, MFP2 and MFP3 (hereinafter also generally referred to as an “image forming apparatus MFP”), and a server SRV connected to allow data communication with these image forming apparatuses through a network NW. Though system 1 including three image forming apparatuses MFP is shown as an example in FIG. 1, the number of image forming apparatuses MFP is not limited. Further, personal computers PC1, PC2 and PC3 (hereinafter also generally referred to as a “personal computer PC”) as user terminals are arranged allowing data communication with the server SRV.

The network NW may be a private line such as LAN (Local Area Network) or WAN (Wide Area Network), or a public line such as virtual private network, which may be partially or fully implemented to realize wireless communication such as wireless LAN. The present invention is applicable to a configuration that allows data communication between the personal computer PC and server SRV and between the server SRV and the image forming apparatus MFP, and therefore, independent networks may be formed to connect these components to each other.

The image forming apparatus MFP includes an operation panel. The operation panel functions as a display portion displaying information related to an operation of each image forming apparatus MFP and it also functions as an input portion for receiving a user operation. Specifically, the operation panel provides a user interface to the image forming apparatus MFP. Particularly, the image forming apparatus MFP in accordance with the present embodiment requests input of a user ID for identifying the user, when the user operates the image forming apparatus MFP. The image forming apparatus MFP obtains customizing information corresponding to the input user ID from the server SRV and, in accordance with the retrieved customizing information, changes the display mode of display on the operation panel. The customizing information is configured to allow setting by each user of the image forming apparatus MFP and each user sets the display image at will to be convenient for use by himself/herself.

In the present embodiment, as a representative example of the image forming apparatus, a multi function peripheral (MFP) having a plurality of functions such as a copying function (monochrome and/or color), a printer function, a facsimile function and image reading function will be described. The apparatus may be a copying machine supporting the copying function only, if it includes the operation panel described above.

The server SRV stores in advance the customizing information of the user for the display image described above and, in response to a request from the image forming apparatus MFP, returns the corresponding customizing information. Here, server SRV transmits the customizing information with items other than those supported by the image forming apparatus of interest deleted. It may be the case that a general user customizes the display image as he/she likes, without considering the functions (capabilities) supported by the image forming apparatus. Therefore, if a display is given based on common customizing information on every image forming apparatus in an office where a plurality of image forming apparatuses are installed, buttons and the like designating unavailable functions would possibly be displayed in some of the image forming apparatuses of lower performance. The server SRV avoids such a situation and provides an appropriate user interface reflecting the capability of each image forming apparatus.

Further, the server SRV provides a setting window on personal computer PC to allow the user to customize the display image of the image forming apparatus MFP. Then, in accordance with the user setting input by the user through the setting window displayed on the personal computer, server SRV stores the customizing information.

Typically, the personal computer PC is a user terminal having a known operating system (OS) installed. In the personal computer PC, a browser application is installed and using the browser application, the setting window is provided.

<Hardware Configuration of Image Forming Apparatus>

FIG. 2 is a schematic diagram showing a hardware configuration of an image forming apparatus MFP in accordance with the embodiment of the present invention.

Referring to FIG. 2, image forming apparatus MFP includes a control portion 100, a memory portion 102, an image reading portion 104, a print portion 106, a network interface (I/F) portion 108, an operation panel 110, and a storage portion 112.

Control portion 100 is typically formed to include an operating device such as a CPU (Central Processing Unit) and executes processes in accordance with the present embodiment by executing a program or programs stored in advance. Memory portion 102 is typically a volatile storage such as a DRAM (Dynamic Random Access Memory), and holds programs executed by control portion 100 and data necessary for executing the programs. Network interface portion 108 is a communication portion for transmitting/receiving data to/from the server SRV (FIG. 1) and the like through the network NW and includes, by way of example, an LAN adapter and driver software for controlling the same. Print portion 106 is a part for the printing process and it includes, in addition to hardware configuration related to the printing process, a control device for controlling actions of various portions. Memory portion 112 is typically a non-volatile memory device such as a hard disk device or a flash memory, and it stores customizing information set by the user and the like.

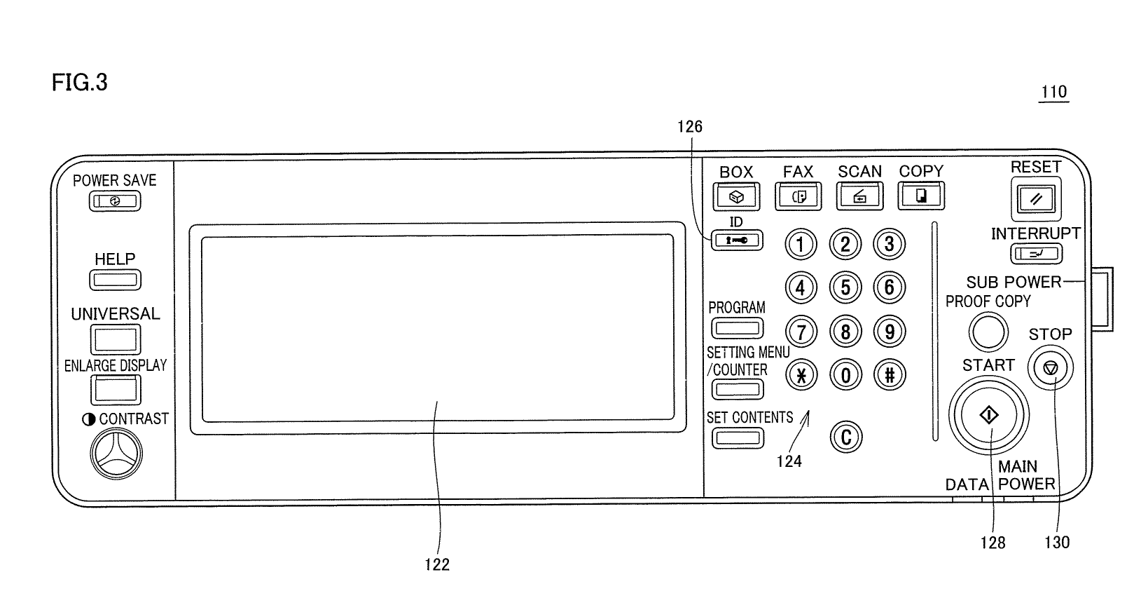

Referring to FIG. 3, operation panel 110 of the image forming apparatus MFP in accordance with the embodiment of the present invention is a user interface, including a plurality of keys such as ten keys 124, a start key 128 and a stop key 130, as well as a touch panel 122.

When a user presses start key 128, a function selected in the image forming apparatus MFP is executed. When the user presses stop key 130, the function that is being executed is halted or stopped. As described above, the image forming apparatus MFP in accordance with the present embodiment requests input of a user ID when the user operates the image forming apparatus MFP. Specifically, if the image forming apparatus MFP is not used by any user, a message asking input of the user ID is displayed on touch panel 122. If the user presses ID key 126 in this state, a window for inputting user ID is displayed on touch panel 122, and the user inputs the user ID to the input window, using ten keys 124 and the like. Then, an image of the display mode corresponding to the input user ID is displayed on touch panel 122. The input user ID may be authenticated in the image forming apparatus MFP or server SRV and, in that case, the image in the display mode corresponding to the input user ID is displayed only when the authentication has been successful. Further, besides the configuration in which the user ID is directly input, the user ID may be obtained by using a device for reading an IC card or the like in a non-contact manner, or by using biometric authentication technique (such as vein authentication or retina verification).

Touch panel 122 includes a liquid crystal panel (LCD: Liquid Crystal Display) for displaying information related to an operation of the image forming apparatus MFP, and a pressure-sensitive panel arranged on the liquid crystal panel and receiving a user operation by sensing pressure applied thereon. Specifically, touch panel 122 displays information to the user and displays buttons corresponding to various operations to the image forming apparatus MFP. When the pressure-sensitive panel detects a user operation at a position corresponding to any of the buttons, an operation corresponding to the button is executed.

<Hardware Configuration of Server and Personal Computer>

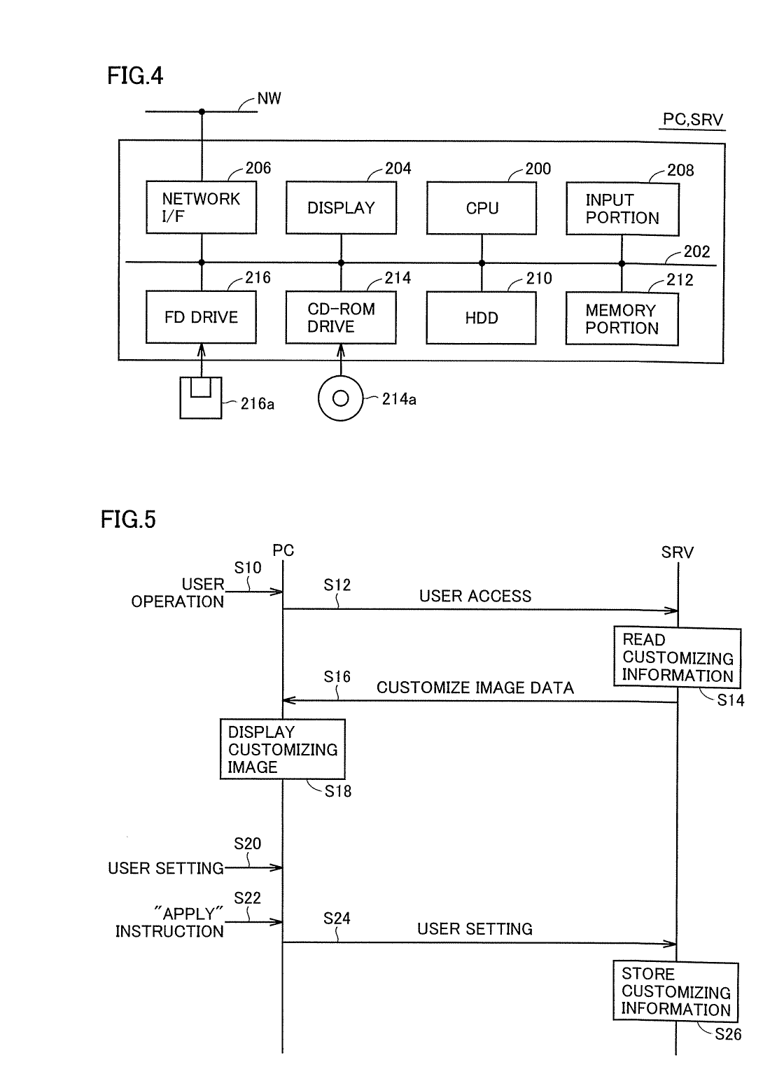

Referring to FIG. 4, the server SRV in accordance with the embodiment of the present invention includes a CPU 200 executing various programs including the operating system, a memory portion 212 temporarily storing data necessary for CPU 200 to execute the programs, and a hard disk portion (HDD) 210 storing the programs executed by CPU 200 in a non-volatile manner. Such a program is read by a CD-ROM (Compact Disk-Read Only Memory) drive 214 or a flexible disk (FD) drive 216, from a CD-ROM 214a or a flexible disk 216a, respectively.

CPU 200 receives an operation request from the user through an input portion 208 implemented by a keyboard and/or a mouse, and provides a screen image output generated by execution of a program to display 204. Further, CPU 200 performs data communication with personal computer PC or image forming apparatus MFP through network interface (I/F) portion 206 provided by an LAN card or the like. These parts are connected to each other through an internal bus 202.

Schematic hardware configuration of personal computer PC is similar to that of FIG. 4 and, therefore, detailed description will not be repeated

<Process for Setting Customizing information>

FIG. 5 represents process procedure related to setting of customizing information in a system 1 in accordance with the embodiment of the present invention.

Referring to FIG. 5, the process of setting of customizing information is realized by the personal computer PC and the server SRV.

Specifically, when the user operates personal computer PC (step S10), a user access is made from personal computer PC to server SRV (step S12). In response to the user access, server SRV reads customizing information stored beforehand (step S14), and retunes image data for customization to the personal computer (step S16). Then, based on the image data, personal computer PC displays a customize image (step S18). Typically, when the setting window for customization is provided on Web basis, the user activates a browser application installed in the personal computer PC and designates a network address (for example, IP address) or a domain name of the server SRV. Then, a request message is transmitted from the browser application to the server SRV and, in response to the request message, text data in the format of HTML (Hypertext Markup Language) or the like, a program described in JAVA®, image data and the like are transmitted from the server SRV to personal computer PC. Then, the browser application of personal computer PC displays the setting window for customization, based on such data.

After such a setting window is displayed, the user inputs his/her favorite setting by operating the keyboard and/or the mouse (step S20). At this time, the user also inputs his/her user ID used for operating the image forming apparatus MFP. Thereafter, when the user applies an “apply” instruction to personal computer PC (step S22), personal computer PC transmits the user setting at that time point to the server SRV (step S24). Then, server SRV stores the customizing information corresponding to the transmitted user setting, in association with the user ID (step S26). The user ID is transmitted together with the user setting. Alternatively, the server SRV may obtain the user ID based on the network address of personal computer PC as the transmission source of the user setting.

By the process procedure described above, the process for setting customizing information is complete.

<Display Process Corresponding to Customizing Information>

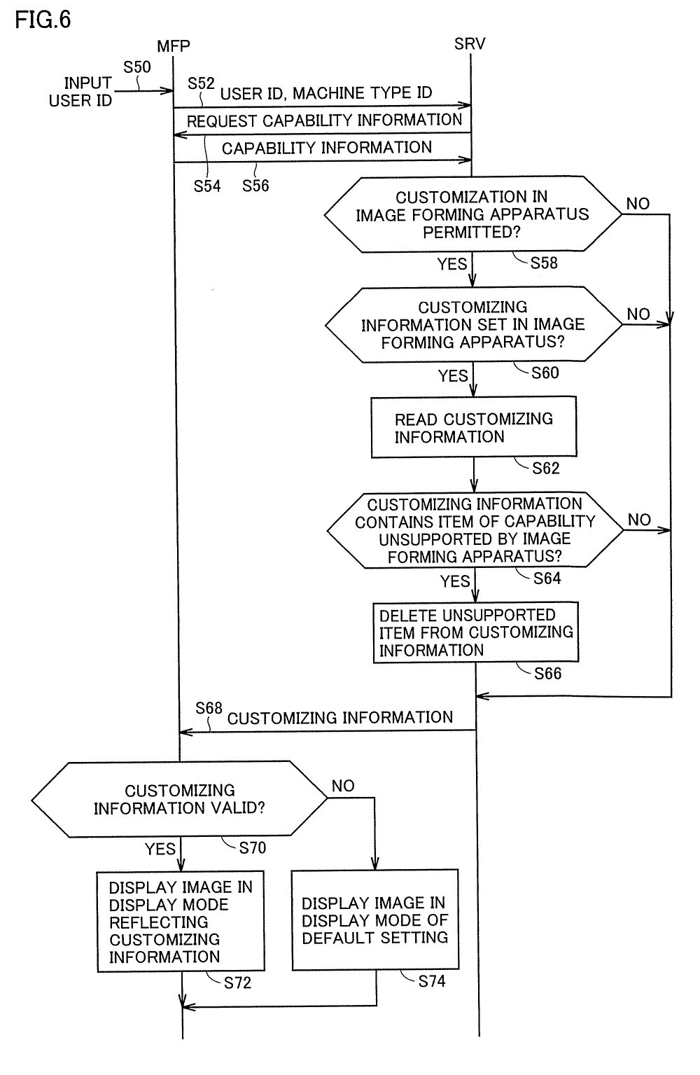

FIG. 6 shows process procedure related to the display corresponding to the customizing information in the image forming apparatus MFP in accordance with the embodiment of the present invention

Referring to FIG. 6, the display corresponding to the customizing information is realized by the process in the image forming apparatus MFP and the server SRV.

First, when the user inputs the user ID (step S50) to operate the image forming apparatus MFP, the image forming apparatus MFP transmits the input user ID and machine type ID of itself to server SRV (step S52). The machine type ID represents identification information uniquely identifying each image forming apparatus and it is also referred to as a device ID.

Receiving the user ID and the machine type ID from any of the image forming apparatuses MFP, server SRV asks the image forming apparatus MFP as the transmission source for capability information (as will be described later) (step S54). In response to the request of capability information, the image forming apparatus MFP transmits capability information representing functions it supports, to the server SRV (step S56). The capability information is stored in advance in each of the image forming apparatuses.

Thereafter, receiving the user ID and the machine type ID from image forming apparatus MFP, server SRV decides whether the user corresponding to the user ID has permitted customization of the imager forming apparatus MFP corresponding to the machine type ID or not (step S58). Specifically, the server SRV has a customizing table (as will be described later) stored beforehand. The customizing table is a table for designating, user by user, which of the at least one piece of customizing information set separately for each image forming apparatus MFP is to be selected. The customizing table includes information as to whether customization of each of the image forming apparatuses is permitted or not for each user. Therefore, server SRV obtains a flag value indicating permission/non-permission of customization corresponding to the received user ID and machine type ID by making a reference to the customizing table, and makes a decision based on the obtained flag value.

If the object user has permitted customization of the object image forming apparatus MFP (YES at step S58), the server decides whether or not the user corresponding to the user ID has set customizing information in the image forming apparatus corresponding to the machine type ID (step S60). Specifically, the server SRV decides whether there is any customizing information corresponding to the received user ID and the machine type ID, by making a reference to the customizing table described above.

If the object user has set the customizing information for the object image forming apparatus MFP (YES at step S60), server SRV reads the set customizing information (step S62). Based on the received capability information, the server SRV decides whether there is any item related to the capability not supported by the image forming apparatus MFP in the read customizing information (step S64).

If there is any item related to the capability not supported by the image forming apparatus MFP contained in the read customizing information (YES at step S64), the server SRV deletes the item corresponding to the capability from the read customizing information, and generates customizing information for transmission (step S66). The object of deletion at step S66 is the customizing information to be transmitted to image forming apparatus MFP, and not the customizing information set in advance by the user

In contrast, if the object user has not permitted customization of the image forming apparatus MFP (NO at step S58), or the object user has not set any customizing information for the object image forming apparatus (NO at step S60), the server SRV does not read the customizing information.

Then, server SRV transmits the customizing information to the object image forming apparatus MFP (step S68). At this time, if the item corresponding to the capability not supported by the image forming apparatus MFP has been deleted at step S66, the server SRV transmits the customizing information with the item deleted. Even when the server SRV has not read the customizing information, it transmits empty (null) customizing information to the object image forming apparatus MFP. This is to notify each image forming apparatus of process completion by the server SRV.

Receiving the customizing information from the server SRV, the image forming apparatus MFP decides whether the customizing information is valid or not (step S70). Specifically, the image forming apparatus MFP decides whether customizing information containing valid information has been received or not.

If the customizing information is valid (YES at step S70), the image forming apparatus MFP displays an image on touch panel 122 in the display mode in accordance with the received customizing information (step S72).

If the customizing information is not valid (NO at step S70), the image forming apparatus MFP displays an image on touch panel 122 in a predetermined display mode (display mode in accordance with default setting) (step S74).

By the process procedure as described above, the process of display in accordance with the customizing information is completed. Then, the user operates the displayed image and executes a desired operation of the image forming apparatus MFP.

<Control Structure>

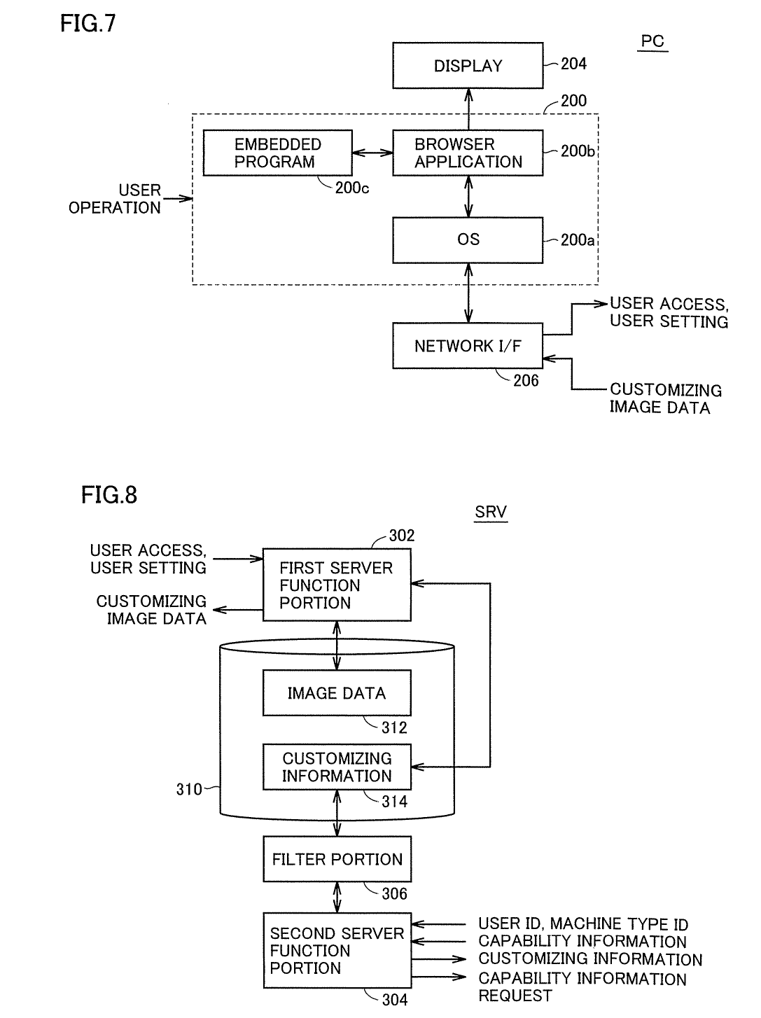

Referring to FIG. 7, in the personal computer PC in accordance with the embodiment of the present invention, CPU 200 (FIG. 4) reads a program stored in hard disk portion 210 (FIG. 4) to memory portion 212 (FIG. 4), and executes the same, whereby an operating system (OS) 200a, a browser application 200b and an embedded program 200c are executed.

Operating system 200a manages hardware and program execution of personal computer PC. Browser application 200b accesses to server SRV, receives the customizing image data from server SRV, and displays a setting window for customizing the display image, on display 204. Embedded program 200c is, for example, JAVA® applet and generates, in cooperation with browser application 200b, the setting window for customization. Further, browser application 200b transmits the input user setting to server SRV.

Referring to FIG. 8, server SRV in accordance with the embodiment of the present invention includes a first server function portion 302, a second server function portion 304, a filter portion 306, and a data storage portion 310, as its functions. The first and second server function portions 302 and 304 are typically realized by CPU 200 (FIG. 4) executing the program stored in advance in hard disk portion 210 (FIG. 4). Data storage portion 310 is formed at a prescribed area in hard disk portion 210 and stores image data 312 and customizing information 314. Image data 312 is the data for displaying the setting window allowing customization, and includes text data, a program, image data and the like as described above. Further, customizing information 314 includes, in addition to the customizing table mentioned above, a customizing information file set by each user.

When there is a user access from any of the personal computers PC, the first server function portion 302 reads image data 312 stored in data storage portion 310 and returns the data to personal computer PC as the access source. Further, receiving a user setting from any of the personal computers PC, the first server function portion 302 updates or adds contents of customizing information 314 stored in data storage portion 310, in accordance with the user setting.

Receiving a user ID and a machine type ID from any of the image forming apparatuses MFP, the second server function portion 304 transmits a capability information request to the image forming apparatus MFP as the transmission source of the user ID and the machine type ID (step S54 of FIG. 6). Thereafter, receiving the capability information from the image forming apparatus MFP, the second server function portion 304 outputs the capability information to filter portion 306.

Filter portion 306 executes a prescribed process (steps S58 to S66 of FIG. 6) based on the user ID) and machine type ID as well as the capability information received from image forming apparatus MFP, and generates customizing information of the transmission source. Further, the second server function portion 304 returns the customizing information generated by filter portion 306 to the image forming apparatus MFP. If prescribed conditions are not satisfied, null customizing information is returned

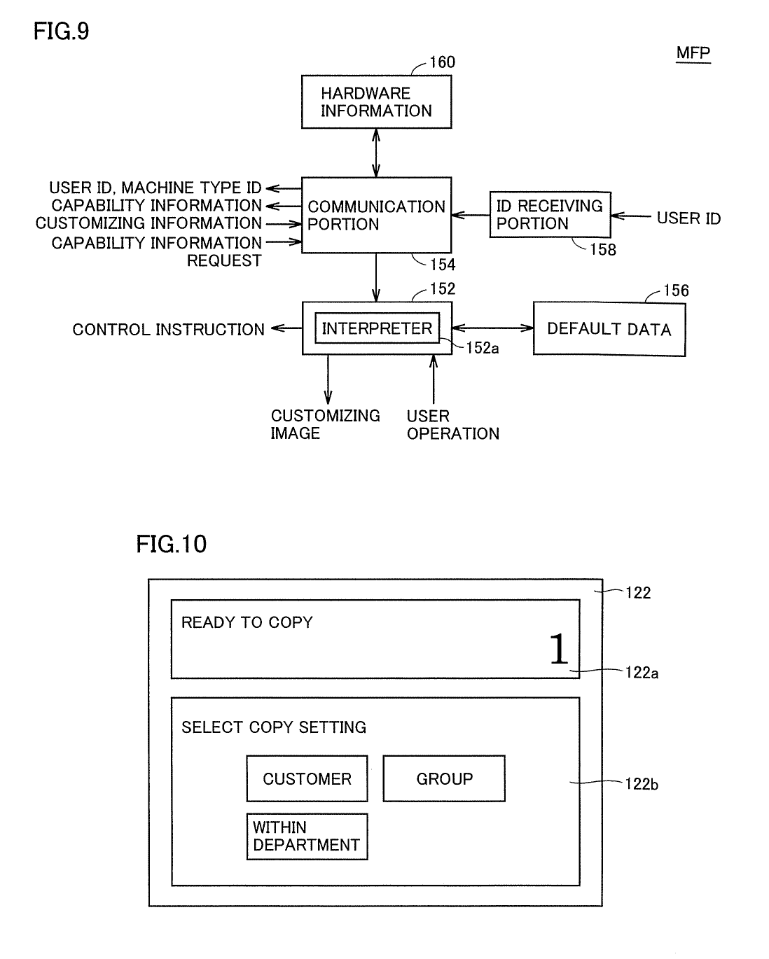

Referring to FIG. 9, the image forming apparatus MFP in accordance with the embodiment of the present invention includes a panel control portion 152, a communication portion 154 and an ID receiving portion 158, as its functions. These functions are typically realized by control portion 100 (FIG. 2) executing a program or programs stored in advance, and all or part of these functions may be realized by hardware. Further, image forming apparatus MFP includes default data 156 and hardware information 160, which are stored in advance in storage portion 112 (FIG. 2) or the like.

ID receiving portion 158 receives the user ID input by the user as he/she operates the image forming apparatus MFP, and using communication portion 154, transmits the user ID to the server SRV.

Receiving the user ID from ID receiving portion 158, communication portion 154 adds a unique machine type ID to the user ID, and transmits the result to a predetermined server SRV. Further, receiving the capability information request from the image forming apparatus MFP, communication portion 154 reads the capability information indicating functions supported by itself from hardware information 160, and returns the read information to server SRV.

Here, capability information means state of functions supported by each of the image forming apparatuses MFP, and typically, the function include a possible print mode (monochrome and/or color), an image reading function (scanner function), a facsimile function, a network printer function, and a finishing function (staple, punch and sort).

Further, receiving the customizing information from server SRV, communication portion 154 outputs the received customizing information to panel control portion 152. Panel control portion 152 generates an image in the display mode corresponding to the received customizing information and displays it on touch panel 122. Further, panel control portion 152 receives a user operation through touch panel 122 and outputs a control instruction in accordance with the user operation to a part such as print portion 106 (FIG. 2) for providing a function of the image forming apparatus MFP.

Particularly, panel control portion 152 includes an interpreter 152a for generating an image from the customizing information. Specifically, the customizing information is formed by a mark-up language as represented by XML (Extensible Markup Language), and interpreter 152a interprets tags included in XML and generates the image of designated display mode. The customizing information will be described later.

As to the correspondence between various functional blocks shown in FIGS. 7 to 9 and the present invention, ID receiving portion 158 corresponds to the “receiving portion,” filter portion 306 corresponds to the “generating portion,” the second server function portion 304 corresponds to the “returning portion,” panel control portion 152 corresponds to the “display control portion,” and the first server function portion 302 corresponds to the “setting portion.”

<Exemplary Display>

In the following, specific examples of display will be described.

Referring to FIG. 10, on touch panel 122 of the image forming apparatus MFP in accordance with the embodiment of the present invention, a status display area 122a and a function allocating area 122b are displayed. Such display mode may arbitrarily customized by each user. Each user may customize MFP by MFP, and in that case, the user may perform setting after designating an image forming apparatus MFP as the object of customization.

Status display area 122a displays status of the image forming apparatus MFP. Here, a status is shown indicating that image forming apparatus MFP supports copying, and the number of copies is set to “1”.

On function allocating area 122b, three buttons (“customer”, “group”, “within department”) arbitrarily set by the user are displayed. The “number” and “arrangement” (layout) of the buttons, displayed “name” and its “font type,” “display color,” and “functions” designated corresponding to respective buttons may be arbitrarily set by the user. Further, items and icons to be displayed may also be set arbitrarily by the user.

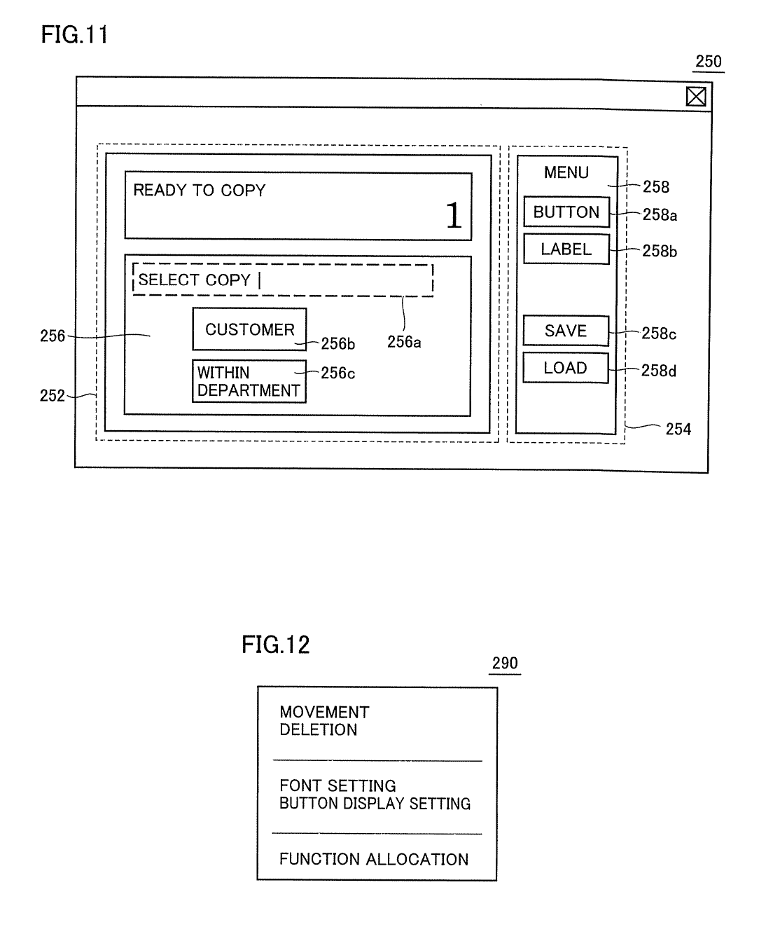

FIG. 11 shows an example of setting window 250 for customization, displayed on the personal computer PC in accordance with the embodiment of the present invention.

Referring to FIG. 11, setting window 250 includes a panel image display area 252 and a menu display area 254.

In the panel image setting area 252, an image of the window to be displayed on touch panel 122 of image forming apparatus MFP is displayed, and the user performs desired customization while viewing the image. In menu display area 254, an operation menu 258 for customization is displayed. As an example of operation menu 258, a button-selection button 258a for adding a button object, a label selection button 258b for adding a label object, a Save button 258c for storing set customizing information to server SRV, a Load button 258d for reading customizing information stored in server SRV and the like are provided.

By way of example, when the display image is to be customized to one shown in FIG. 10, the user operates the keyboard and/or the mouse to select button-selection button 258a, and thereafter designates positions of arrangement of button objects 256b and 256c. Further, the user selects label selection button 258b and thereafter designates the position of arrangement of label object 256a. Further, the user operates the keyboard and the like to input a character sequence and the like to be displayed on the label object 256a. When customization is complete, the user selects Save button 258c. Then, the currently set user setting is transmitted to server SRV. When the user selects Load button 258d, the customizing information that has already been stored in the server SRV is read, and the user may make addition to or update the read customizing information. Alternatively, a configuration is also possible in which, when the user selects Load button 258d, a default setting set in a specific image forming apparatus MFP may be obtained, allowing addition to or updating of the default setting.

When a once arranged object is to be changed on setting window 250 shown in FIG. 11, for example, the user moves a cursor to the target object and “right-clicks” the mouse. Then, an advanced setting menu 290 such as shown in FIG. 12 is displayed. Advanced setting menu 290 allows selection of “movement” for moving an object, “deletion” for deleting an object, “font setting” for setting font, character size, character color, background color and the like of character sequences to be displayed, “button display setting” for setting object size, background color and the like, and “function allocation” for setting a function of the image forming apparatus MFP in correspondence with the object.

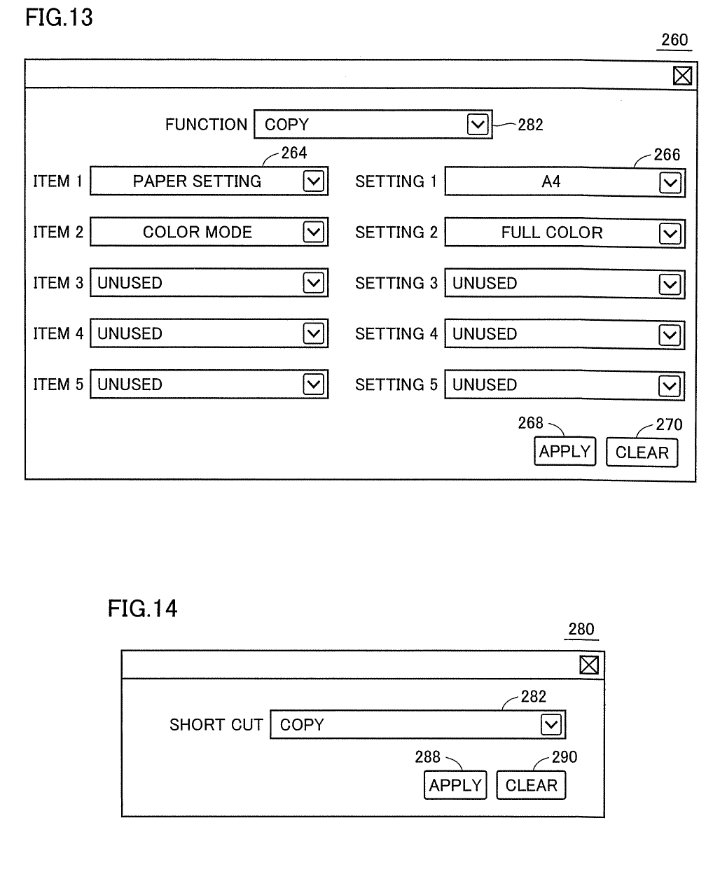

When the user selects any object on the setting window 250 shown in FIG. 11, invokes a display of advanced setting menu 290 shown in FIG. 12 and selects “function allocation” therein, an advanced item setting window 260 shown in FIG. 13 appears.

Referring to FIG. 13, on advanced item setting window 260, a function selection portion 282 is arranged, allowing selection of a function of image forming apparatus MFP to be allocated to the selected object. Function selection portion 282 allows selection of a function to be allocated to the object from the functions of image forming apparatus MFP including the copying function, printer function, facsimile function and image reading function, in a pull-down menu form. If an image forming apparatus as the object of setting has been designated beforehand, such a display may be given that allows selection of only the functions supported by the image forming apparatus. For instance, if an image forming apparatus MFP only supporting the copying function is designated, a display allowing selection of copying only is given.

If any function is selected at function selection portion 282, selectable items are extracted by item selecting portion 264 in accordance with the selected function, and the extracted items are displayed in the form of a pull-down menu to allow selection. By way of example, if “copy” (copying function) is selected by function selection portion 282, item selection portion 264 allows selection of “color mode (monochrome/color)”, “paper setting” and the like, as setting items for the copying function.

In correspondence with the item or items selected at item selection portion 264, at least one setting value is displayed in the form of a pull-down menu to allow selection, at setting selection portion 266. For instance, if “paper setting” is selected at item selection portion 264, setting selection portion 266 allows selection of setting values such as “A3”, “A4” and “A5”.

Displays of item selection portion 264 and setting selection portion 266 may also be adapted to allow selection of only items supported by the image forming apparatus MFP, if the image forming apparatus MFP as the object of setting has been designated in advance.

When the user selects an APPLY button 268, each item selected as described above is reflected as the set value of the object. If a CLEAR button 270 is selected, contents of each set item are cleared.

In place of the approach in which advanced setting is allocated to each object as described above, standard functions set in advance for the image forming apparatus MFP may be set. Specifically, an object may be set as a short-cut key to a standard function of the image forming apparatus MFP. If such an approach is taken, the user selects any object on setting window 250 shown in FIG. 11 and invokes a display of a short-cut setting window 280 such as shown in FIG. 14. Short-cut setting window 280 allows selection of functions as destinations of short-cut (functions supported by image forming apparatus MFP) in the form of a pull-down menu. After selection of a short-cut function, when the user selects APPLY button 268, each selected item is reflected as the set value of the selected object. If CLEAR button 270 is selected, contents of each set item are cleared.

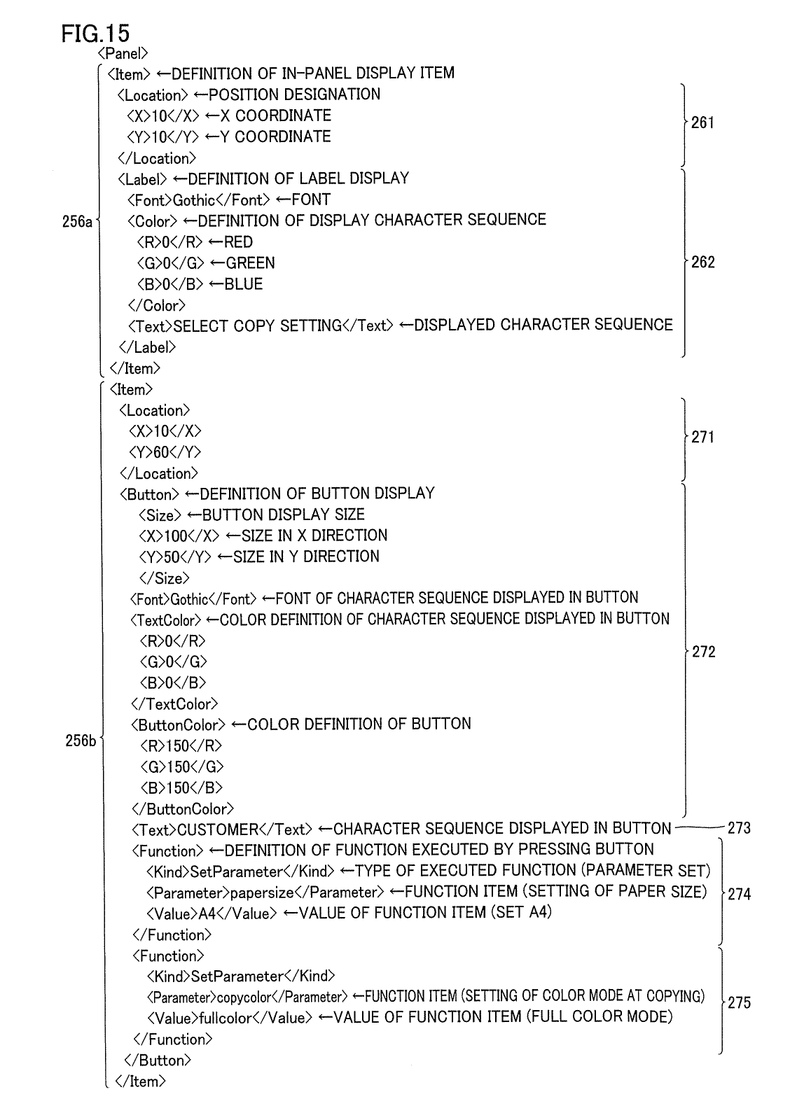

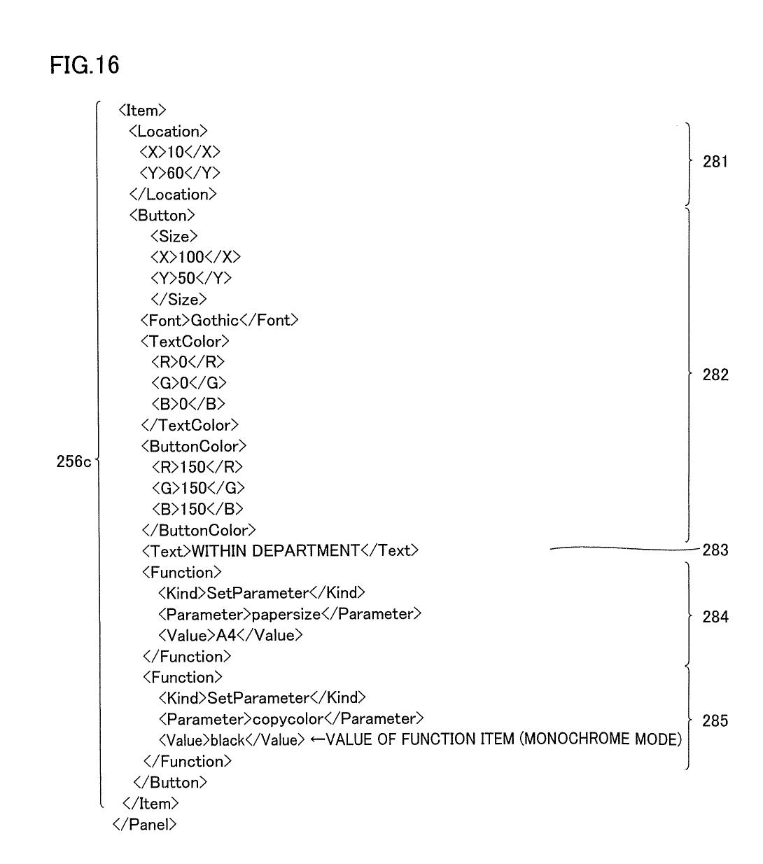

FIGS. 15 and 16 show examples of source code of customizing information generated through setting window 250 shown in FIG. 11.

Referring to FIGS. 15 and 16, customizing information is described, by way of example, in XML format and the contents are described by the attribute designated by a start tag < > and the text designated between the start tag < > and the end tag </>.

Referring to FIG. 15, for instance, setting for label object 256a of FIG. 11 corresponds to the descriptions between the first start tag <Item> to the next end tag </Item>. The setting includes a description 261 setting position of arrangement of label object 256a and a description 262 setting a title of label object 256a.

Further, setting for button object 256b of FIG. 11 corresponds to the descriptions between the second start tag <Item> to the next end tag </Item>. The setting includes a description 271 setting position of arrangement of button object 256b, a description 272 setting font and display color of button object 256b, a description 273 setting title of button object 256b, a description 274 setting a function related to button object 256b, and a description 276 setting details of the function related to button object 256b. Further, referring to FIG. 16, setting for button object 256c includes descriptions 281 to 285 similar to those for button object 256b.

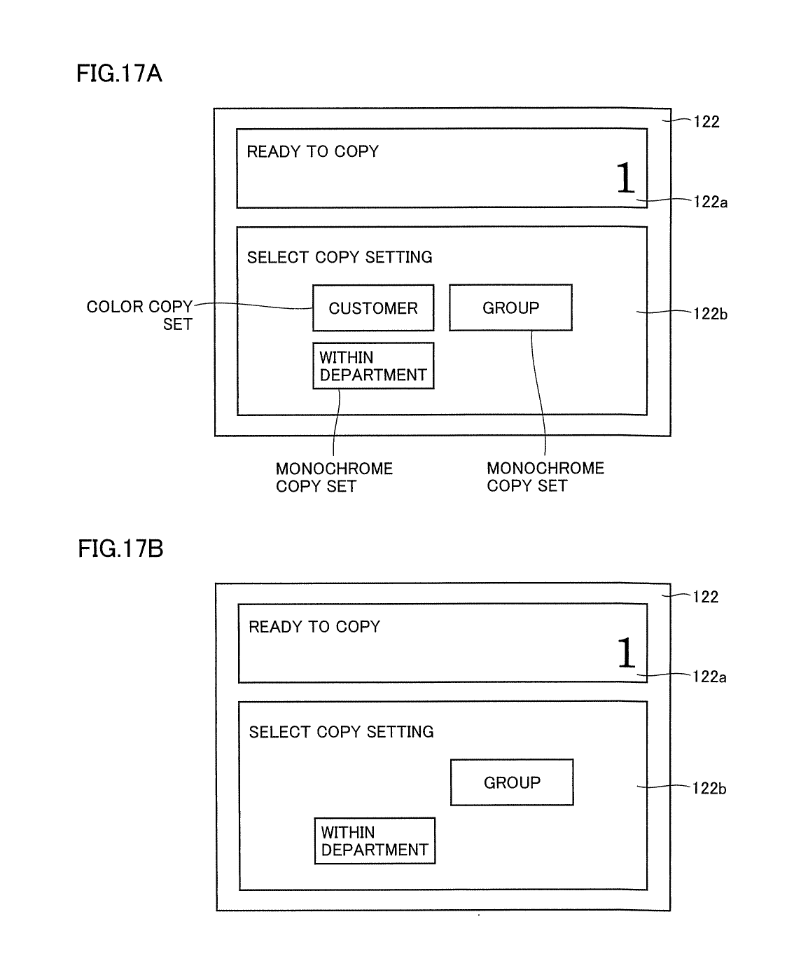

FIG. 17A shows an example in which customizing information has only items that are supported by the image forming apparatus MFP, and FIG. 17B shows an example in which customizing information has an item or items not supported by the image forming apparatus MFP.

Referring to FIG. 17A, if the image forming apparatus MFP supports all the capabilities corresponding to the items set in the customizing information, all items are displayed as in FIG. 10.

By way of example, assume that of the three button displays (“customer”, “group” and “within department”) on function allocation area 122b, “customer” is set for color copy and other “group” and “within department” are for monochrome copy. If the image forming apparatus supports the color printing function, image display such as shown in FIG. 17A appears.

In contrast, if the image forming apparatus MFP supports the monochrome printing function only, image display such as shown in FIG. 17B appears. This is realized as the server SRV deletes the item of “customer” button display as an item not available without color printing function and transmits the customizing information with the item deleted, to the image forming apparatus MFP of interest.

In this manner, button display for designating color printing does not appear in the image forming apparatus MFP supporting only the monochrome printing function and, therefore, erroneous operation by the user can be prevented.

<Other Exemplary Displays>

In addition to the image displays described above, images may be displayed in various display modes on touch panel 122 of image forming apparatus MFP.

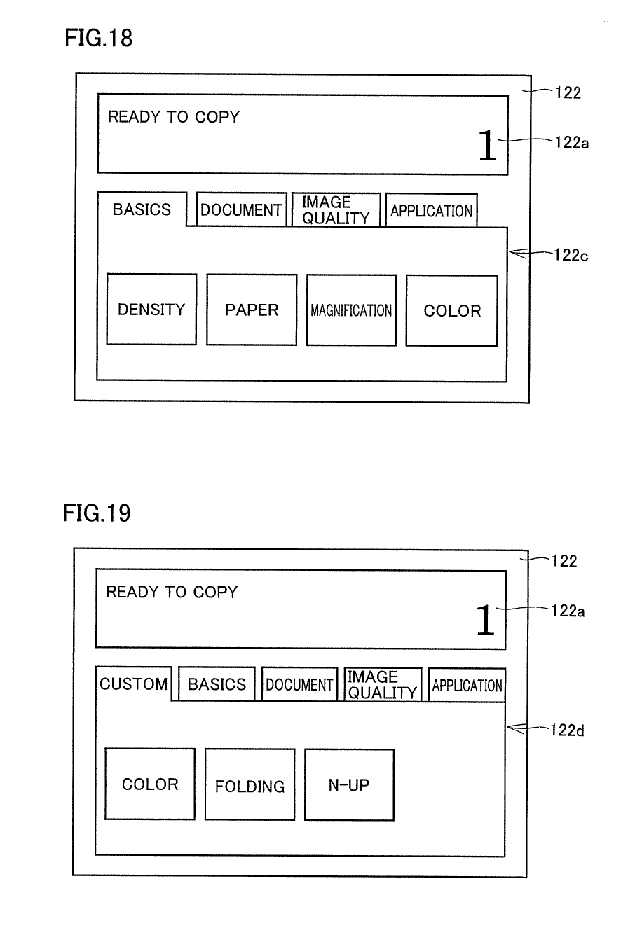

FIGS. 18 to 20 show other examples of display given on touch panel 122 of image forming apparatus MFP in accordance with the embodiment of the present invention.

Referring to FIG. 18, if a display allowing switching among a plurality of display images using tabs is provided on function allocation area 122c, buttons for selecting functions frequently used by each user may be allocated on the image that is displayed first (in FIG. 18, image with “BASICS” tab).

Referring to FIG. 19, if a display allowing switching among a plurality of display images using tabs is provided as in FIG. 18, a display image exclusively for user setting (image with “CUSTOM” tab in FIG. 19) may be added. In that case, it is preferred to display the image with “CUSTOM” tab first.

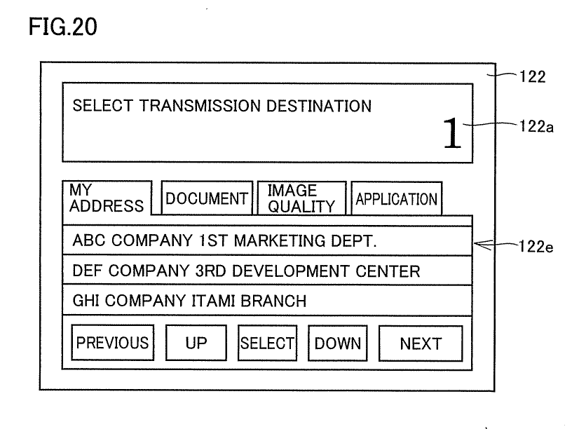

Referring to FIG. 20, in addition to buttons for selecting functions of the image forming apparatus, if the facsimile transmission function or scanning function is supported, addresses to be selected as transmission destination by each user may be set in advance. Similar to customization described above, such addresses may be set by each user on the personal computer PC.

<Modification 1>

In the foregoing, a configuration in which each image forming apparatus transmits capability information of itself to the server SRV has been described. It is also possible for the server to collectively manage capability information of each image forming apparatus. Such a configuration will be described in the following.

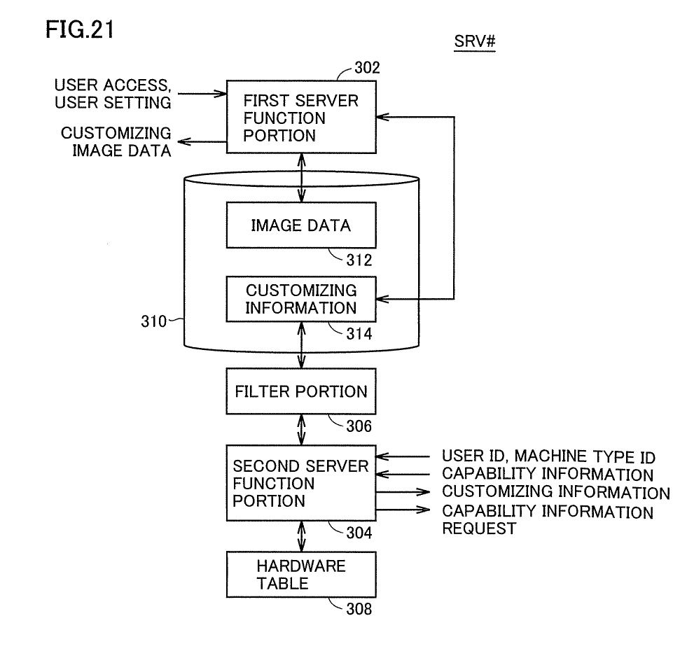

Referring to FIG. 21, a server SRV# in accordance with Modification 1 of the embodiment of the present invention corresponds to the server SRV shown in FIG. 8, additionally having a hardware table 308. Other portions are the same and, therefore, detailed description will not be repeated.

Hardware table 308 stores capability information indicating capabilities supported by each image forming apparatus MFP, in correspondence with a plurality of image forming apparatuses connected to one same network NW. The capability information stored in hardware table 308 is substantially the same as the capability information stored in hardware information 160 of each image forming apparatus shown in FIG. 9. Further, in hardware table 308, typically, the capability information is stored in correspondence with the machine type ID of each image forming apparatus MFP. Storage of capability information in hardware table 308 may be manually done by an administrator when a new image forming apparatus MFP is connected to the network NW, or may be done by utilizing communication function through the network NW.

Receiving the user ID and the machine type ID from any of the image forming apparatuses MFP, the second server function portion 304 looks up the hardware table 308 using the machine type ID as a key, and obtains the corresponding capability information. Then, the second server function portion 304 outputs the capability information to filter portion 306.

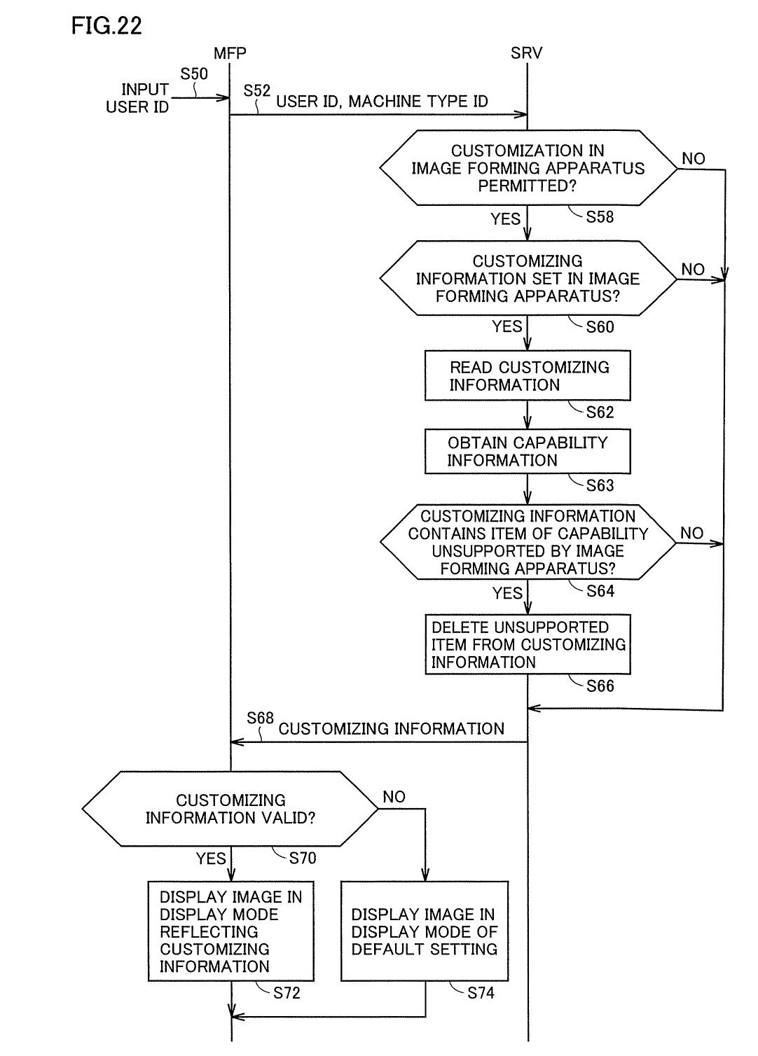

FIG. 22 shows process procedure related to display in accordance with the customizing information in the image forming apparatus MFP in accordance with Modification 1 of the embodiment of the present invention.

Referring to FIG. 22, the process procedure in accordance with Modification 1 of the embodiment corresponds to the process procedure in accordance with Embodiment 1 shown in FIG. 6 with steps S54 and S56 omitted and step S63 added.

Specifically, in the process procedure shown in FIG. 22, even when the server SRV receives a user ID and a machine type ID from any image forming apparatus MFP, it does not ask the image forming apparatus MFP as the transmission source for the capability information. Instead, the server SRV reads the customizing information (step S62), refers to hardware table 308, and obtains the capability information corresponding to the machine type ID received at step S52 (step S63) Then, the server SRV executes subsequent processes based on the obtained capability information.

Other configuration and processes are the same as those described above and, therefore, detailed description will not be repeated.

As described above, in Modification 1 of the embodiment of the present invention, server SRV# collectively manages the capability information of image forming apparatuses MFP and, therefore, even when there are a large number of image forming apparatuses MFP, management of capability information of the apparatuses can be simplified. Further, as it is unnecessary to transmit the capability information request and the capability information between the server SRV and the image forming apparatus MFP, communication load between the two can be reduced.

<Modification 2>

In the description of the embodiment of the present invention above, a configuration has been disclosed as an example in which the user customizes, on the personal computer, the display image of the image forming apparatus MFP. The invention is not limited to such a configuration. By way of example, the display image may be customized on any of the image forming apparatuses MFP, and the corresponding customizing information may be transmitted from the image forming apparatus to the server SRV. In that case, when each user logs off from the image forming apparatus MFP, whether the customization made on the image forming apparatus should be reflected to other image forming apparatuses or not may be selected.

### Effects of the Embodiment

According to the embodiment of the present invention, the user may customize the image forming apparatus MFP beforehand so that a desired image is displayed, and may store the customizing information in the server SRV. Then, when the user inputs a user ID to operate any image forming apparatus, the user ID is transmitted to the server SRV and from the server SRV, the customizing information corresponding to the user ID is returned to the image forming apparatus. Further, the image forming apparatus MFP provides image display in a display mode in accordance with the returned customizing information. Therefore, even if there are a large member of image forming apparatuses MFP, the trouble of customization by each user can be reduced, and a user interface preferred by each user can be realized in a plurality of image forming apparatuses through a simple setting operation.

Further, according to the embodiment of the present invention, even when various and many items are set as user customizing information, only the available items are selectively displayed, reflecting the capability of the image forming apparatus on which the image is displayed Therefore, button display requesting an unsupported function can be avoided, and erroneous operation by the user can be prevented. Therefore, a user interface appropriate for the capability of the image forming apparatus can be provided.

Further, according to the embodiment of the present invention, each user can set customizing information for each image forming apparatus MFP. Therefore, it is possible, for example, to display images in different display modes on image forming apparatuses having different functions (image forming apparatus MFP supporting monochrome copy only and image forming apparatus MFP also supporting color copy). Thus, more convenient user interface can be provided.

### Other Embodiments

The program in accordance with the present invention may be realized by calling necessary modules in a prescribed sequence at prescribed timings to execute processes, from program modules provided as part of the operating system (OS) of a computer. In such a case, the program itself does not include the modules mentioned above, and the processes are executed in cooperation with the OS. Such program not including the modules is also encompassed by the present invention.

Further, the program in accordance with the present invention may be provided incorporated as a part of another program. In that case also, the program itself does not include the modules included in said another program, and the processes are executed in cooperation with said another program. Such a program incorporated in another program is also encompassed by the present invention.

The program product provided by the invention is executed installed in a program storage such as a hard disk. The program product includes the program itself and a storage medium storing the program.

Further, part of or all of the functions realized by the program in accordance with the present invention may be implemented by dedicated hardware.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A system, comprising:
a plurality of image forming apparatuses; and
a server capable of data communication with said plurality of image forming apparatuses; wherein
each of said image forming apparatuses includes
a display portion displaying information related to an operation of the image forming apparatus, and
a receiving portion receiving identification information identifying a user using the image forming apparatus and transmitting the identification information to the server;
said server includes
a storage portion for storing first setting information set user by user in advance,
a generating portion responsive to said identification information from said image forming apparatus, for generating second setting information by deleting any item other than those supported by the image forming apparatus from the first setting information corresponding to said identification information, and
a returning portion returning said second setting information to the image forming apparatus; and
each of said plurality of image forming apparatuses further includes
a display control portion providing, on said display portion, information related to said operation in a display mode based on said second setting information returned from said server.

2. The system according to claim 1, wherein
each of said plurality of image forming apparatuses further includes
a capability information transmitting portion transmitting capability information indicating a function supported by itself to said server; and
said generating portion generates said second setting information based on said capability information from said image forming apparatus.

3. The system according to claim 1, wherein
said server further includes a table for storing beforehand capability information indicating a function supported by each of the image forming apparatuses, in correspondence with the plurality of image forming apparatuses; and
said generating portion looks up said table to obtain capability information corresponding to the image forming apparatus as a transmission source of said identification information, and generates said second setting information based on the obtained capability information.

4. The system according to claim 1, wherein
said storage portion is capable of storing, user by user, at least one piece of said first setting information for each of said image forming apparatuses; and
said returning portion returns that piece of first setting information which corresponds to the image forming apparatus as the transmission source of said identification information, to the image forming apparatus.

5. The system according to claim 1, wherein
said display control portion displays said information related to the operation in a predetermined, prescribed display mode, if said second setting information is not effectively returned from said server.

6. The system according to claim 1, further comprising
a user terminal capable of data communication with said server, wherein
said server further includes a setting portion invoking a display of an image for setting said first setting information on said user terminal and storing said first setting information in said storage portion in accordance with a set value input through said user terminal.

7. The system according to claim 1, wherein
said first setting information includes a setting value for at least one of display items, a layout, a font type and a color.

8. A display method in a system including a plurality of image forming apparatuses and a server capable of data communication with said plurality of image forming apparatuses, wherein
each of said image forming apparatuses includes a display portion displaying information related to an operation of the image forming apparatus;
said server includes
a storage portion for storing first setting information set user by user in advance;
said display method comprising the steps of
said image forming apparatus receiving identification information for identifying a user who uses it, and transmitting the identification information to said server;
in response to said identification information from said image forming apparatus, said server generating second setting information by deleting any item other than those supported by the image forming apparatus from the first setting information corresponding to said identification information;
said server returning said second setting information to the image forming apparatus; and
said image forming apparatus displaying said information related to an operation in a display mode based on said second setting information returned from said server.

9. The display method according to claim 8, further comprising the step of
said image forming apparatus transmitting capability information indicating a function supported by itself to said server; wherein
said generating step includes the step of generating said second setting information based on said capability information from said image forming apparatus.

10. The display method according to claim 8, wherein
said server further includes a table for storing beforehand capability information indicating a function supported by each of the image forming apparatuses, in correspondence with the plurality of image forming apparatuses; and
said generating step includes the step of looking up said table to obtain capability information corresponding to the image forming apparatus as a transmission source of said identification information, and generating said second setting information based on the obtained capability information.

11. The display method according to claim 8, wherein
said storage portion is capable of storing, user by user, at least one piece of said first setting information for each of said image forming apparatuses; and
said returning step includes the step of returning that piece of first setting information which corresponds to the image forming apparatus as the transmission source of said identification information, to the image forming apparatus.

12. The display method according to claim 8, wherein
said displaying step includes the step of
displaying said information related to the operation in a predetermined, prescribed display mode, if said second setting information is not effectively returned from said server.

13. The display method according to claim 8, wherein
said system further includes a user terminal capable of data communication with said server;
said display method further comprising the step of
said server invoking a display of an image for setting said first setting information on said user terminal and storing said first setting information in said storage portion in accordance with a set value input through said user terminal.

14. The display method according to claim 8, wherein
said first setting information includes a setting value for at least one of display items, a layout, a font type and a color.

15. A server capable of data communication with a plurality of image forming apparatuses and with a user terminal, wherein
each of said plurality of image forming apparatuses includes a display portion displaying information related to an operation of the image forming apparatus; and
said server comprising
a storage portion for storing first setting information set user by user in advance, for defining display mode of said information related to an operation in said image forming apparatus;
a setting portion invoking a display of an image for setting said setting information in said user terminal, and storing said setting information in said storage portion in accordance with a set value input through said user terminal;
a generating portion responsive to reception of identification information for identifying a user from said image forming apparatus, generating second setting information by deleting any item other than those supported by the image forming apparatus from the first setting information corresponding to said identification information; and
a returning portion returning said second setting information to the image forming apparatus.
